(19) United States
(12) Patent Application Publication
(10) Pub. No.: US 2026/0359135 A1
(43) Pub. Date: Nov. 12, 2026

(54) RESOURCE RELOADING METHOD AND APPARATUS, ELECTRONIC DEVICE, AND STORAGE MEDIUM

(71) Applicant: SHENZHEN TCL NEW TECHNOLOGY CO., LTD., Shenzhen, Guangdong (CN)

(72) Inventor: Fan WANG, Shenzhen, Guangdong (CN)

(73) Assignee: SHENZHEN TCL NEW TECHNOLOGY CO., LTD., Shenzhen, Guangdong (CN)

(21) Appl. No.: 19/475,055

(22) PCT Filed: Mar. 20, 2024
(86) PCT No.: PCT/CN2024/082727

§ 371 Date: Oct. 13, 2025

(30) Foreign Application Priority Data
Apr. 14, 2023 (CN) 202310438089.9

(51) Int. Cl. G06F 9/50; G06F 9/445; G06F 9/54

(52) U.S. Cl. CPC G06F 9/505; G06F 9/44505; G06F 9/542

(57) ABSTRACT

The present disclosure provides a resource reloading method and apparatus, an electronic device, and a computer readable medium. The method includes: in response to a configuration update event, acquiring initial current configuration information, wherein the initial current configuration includes extended configuration sub-information with a configuration modification identifier; adjusting the configuration modification identifier based on the configuration update event to obtain target current configuration information; acquiring historical configuration information, wherein the historical configuration information includes historical extended configuration sub-information with a historical configuration modification identifier; determining a configuration change result corresponding to the configuration update event based on the configuration modification identifier in the target current configuration information and the historical configuration modification identifier; and performing resource reloading based on configuration data of the configuration update event when the configuration change result shows configuration has been changed.

The present disclosure claims the priority of the Chinese patent application titled “RESOURCE RELOADING METHOD AND APPARATUS, ELECTRONIC DEVICE, AND STORAGE MEDIUM”, with application number 202310438089.9, submitted to the China National Intellectual Property Administration on Apr. 14, 2023, the entire content of which is incorporated herein by reference.

### TECHNICAL FIELD

The present disclosure relates to the field of computer technology, and specifically to a resource reloading method and apparatus, electronic device, and storage medium.

### BACKGROUND

With rapid economic and technological development, users increasingly demand higher functionality, experience, and interaction when using electronic products. Many operating systems or applications support custom settings to enhance user experience.

### SUMMARY

Current implementations of custom settings primarily involve reloading resources according to user settings to achieve updates that meet user requirements. However, this approach generally requires restarting the application or operating system to complete resource reloading, preventing user settings from taking effect immediately and thereby impacting user experience.

Embodiments of the present disclosure provide a resource reloading method and apparatus, electronic device, and storage medium, which enable resource reloading without restarting applications or systems, thereby improving user experience and achieving immediate effect of resource reloading.

Embodiments of the present disclosure provide a resource reloading method. The method includes: in response to a configuration update event, acquiring initial current configuration information, wherein the initial current configuration comprises extended configuration sub-information with a configuration modification identifier; adjusting the configuration modification identifier based on the configuration update event to obtain target current configuration information; acquiring historical configuration information, wherein the historical configuration information comprises historical extended configuration sub-information with a historical configuration modification identifier; determining a configuration change result corresponding to the configuration update event based on the configuration modification identifier in the target current configuration information and the historical configuration modification identifier; and performing resource reloading based on configuration data of the configuration update event when the configuration change result shows configuration has been changed.

Correspondingly, embodiments of the present disclosure provide a resource reloading apparatus. The apparatus includes: a first information acquisition unit configured to: in response to a configuration update event, acquire initial current configuration information, wherein the initial current configuration comprises extended configuration sub-information with a configuration modification identifier; an identifier adjustment unit configured to: adjust the configuration modification identifier based on the configuration update event to obtain target current configuration information; a second information acquisition unit configured to: acquire historical configuration information, wherein the historical configuration information comprises historical extended configuration sub-information with a historical configuration modification identifier; a result determination unit configured to: determine a configuration change result corresponding to the configuration update event based on the configuration modification identifier in the target current configuration information and the historical configuration modification identifier; and a resource reloading unit configured to: perform resource reloading based on configuration data of the configuration update event when the configuration change result shows configuration has been changed.

In some embodiments, the current configuration information further comprises original configuration sub-information, and the historical configuration information comprises historical original configuration sub-information. The result determination unit is configured to: determine an information change result corresponding to the configuration update event based on the original configuration sub-information in the target current configuration information and the historical original configuration sub-information in the historical configuration information; compare the configuration modification identifier in the target current configuration information with the historical configuration modification identifier in the historical configuration information to determine an identifier change result corresponding to the configuration update event; determine the configuration change result corresponding to the configuration update event based on the identifier change result and the information change result.

In some embodiments, the result determination unit is configured to: take the initial current configuration information as invocation parameters to call a configuration update method in a process management service, wherein the configuration update method comprises a configuration information comparison method; compare the original configuration sub-information with the historical original configuration sub-information through the configuration information comparison method to determine the information change result.

In some embodiments, the original configuration sub-information comprises at least one type of original device configuration feature, and the historical original configuration sub-information comprises at least one type of historical original device configuration feature. Types of the historical original device configuration feature and the original device configuration feature are identical. The result determination unit is configured to: use the configuration information comparison method to compare the original device configuration feature in the original configuration sub-information with the historical original device configuration feature in the historical original configuration sub-information of a same type to determine the information change result.

In some embodiments, the result determination unit is configured to: collect invocation information of the configuration information comparison method through a preset program probe; invoke an extended configuration comparison method for the extended configuration sub-information based on the invocation information; compare the configuration modification identifier in the target current configuration information with the historical configuration modification identifier in the historical configuration information through the extended configuration comparison method to determine the identifier change result corresponding to the configuration update event.

In some embodiments, the identifier adjustment unit is configured to: determine an update condition corresponding to the configuration update event based on the configuration update event; when the update condition belongs to a preset configuration modification criteria, obtain a target modification identifier corresponding to the update condition from a predefined modification identifier set; modify an attribute value of the configuration modification identifier to the target modification identifiers to obtain the target current configuration information.

In some embodiments, the configuration data comprise target display data. The resource reloading unit is configured to: when the configuration change result shows configuration has been changed, acquire target display data corresponding to the configuration update event; halt process restarting, and reload resources for original display data based on the target display data to render a visual effect corresponding to the target display data.

Correspondingly, embodiments of the present disclosure further provide an electronic device. The electronic device includes a memory and a processor. The memory is configured to store application programs, that when executed by the processor, cause the processor to perform the resource reloading method according to any embodiment of the present disclosure.

Correspondingly, embodiments of the present disclosure further provide a computer readable medium. The computer readable medium stores instructions that, when executed by a process, cause the processor to perform the resource reloading method according to any embodiment of the present disclosure.

In addition, embodiments of the present disclosure further provide a computer program product. The computer program product includes instructions that, when executed by a process, cause the processor to perform the resource reloading method according to any embodiment of the present disclosure.

### Technical Effects

By adopting the solution described in embodiments of the present disclosure, in response to a configuration update event, initial current configuration information can be obtained. The initial current configuration information includes extended configuration sub-information containing a configuration modification identifier. Based on the configuration update event, the configuration modification identifier is adjusted to derive target current configuration information. Historical configuration information is acquired, which includes historical extended configuration sub-information containing a historical configuration modification identifier. The configuration modification result corresponding to the configuration update event is determined based on the configuration modification identifier in the target current configuration information and the historical configuration modification identifier. When the configuration modification result indicates a configuration change, resource reloading is performed based on the configuration data of the configuration update event. In embodiments of the present disclosure, the mechanism for determining whether resource reloading is required is established through the extended configuration sub-information which is additionally configured. Implementation of such solution may enable resource reloading without restarting applications or systems, thereby improving user experience and achieving immediate effect of resource reloading.

### BRIEF DESCRIPTION OF THE DRAWINGS

In order to clearly explain the technical solutions in the embodiments of the present disclosure, the drawings used in the description of the embodiments will be briefly described below. Obviously, the drawings in the following description are merely some embodiments of the present disclosure. For those of ordinary skill in the art, other drawings may also be obtained based on these drawings without any creative work.

FIG. 1 is a schematic diagram of a scenario for the resource reloading method according to an embodiment of the present disclosure.

FIG. 2 is a flowchart of a resource reloading method according to an embodiment of the present disclosure.

FIG. 3 is a schematic UML class diagram of configuration information according to an embodiment of the present disclosure.

FIG. 4 is a schematic diagram of a configuration modification-triggered application update process according to an embodiment of the present disclosure.

FIG. 5 is a structural schematic diagram of a resource reloading apparatus according to an embodiment of the present disclosure.

FIG. 6 is a structural schematic diagram of an electronic device according to an embodiment of the present disclosure.

### DETAILED DESCRIPTION

The disclosure will now be described in detail with reference to the accompanying drawings and examples. Apparently, the described embodiments are only a part of the embodiments of the present disclosure, not all of the embodiments. All other embodiments obtained by a person of ordinary skill in the art based on the embodiments of the present invention without creative efforts shall fall within the protection scope of the present invention.

The present disclosure provides a resource reloading method and apparatus, electronic device, and computer-readable storage medium. Specifically, embodiments of the present disclosure provide a resource reloading method applicable to a resource reloading apparatus, which may be integrated into an electronic device.

The electronic device may include terminal devices such as, but not limited to, mobile terminals and fixed terminals. For example, mobile terminals include, but are not limited to, smartphones, smartwatches, tablets, laptops, and smart vehicle-mounted devices. Fixed terminals include, but are not limited to, desktop computers and smart TVs.

The electronic device may also include Server (SRV) devices, which could be, but are not limited to, standalone physical servers, server clusters, distributed systems, or cloud servers providing fundamental cloud computing services such as cloud services, cloud databases, cloud computing, cloud functions, cloud storage, network services, cloud communications, middleware services, domain services, security services, CDN (Content Delivery Network), big data, and artificial intelligence platforms.

The resource reloading method in embodiments of the present disclosure may be implemented by a server or, or be jointly implemented by a terminal and a server.

The following uses the example of a terminal and a server jointly implementing the resource reloading method for explanation.

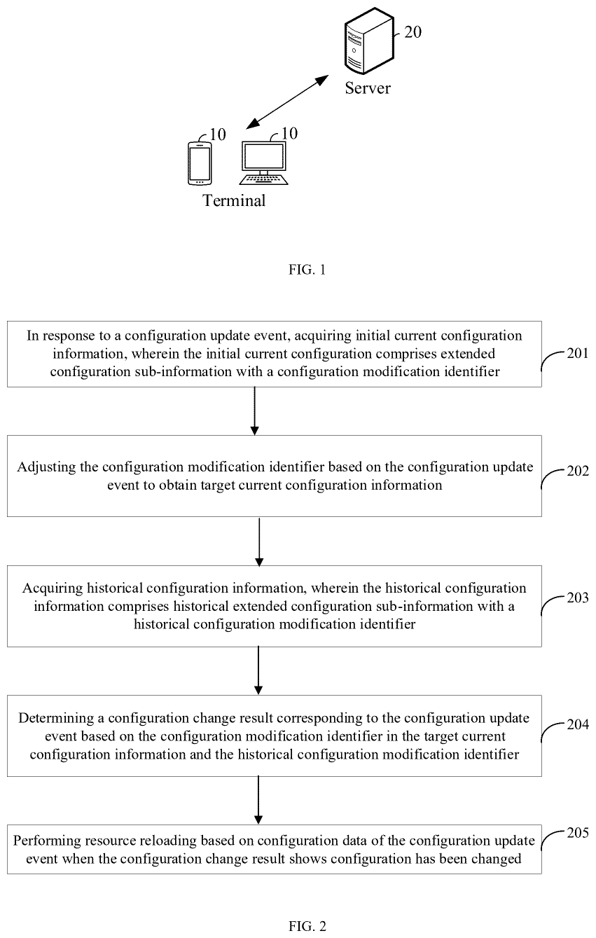

As shown in FIG. 1, the resource reloading system provided in embodiments of the present disclosure includes a terminal 10 and a server 20. The terminal 10 and the server 20 are connected via network connection, such as through wired or wireless network connections. The terminal 10 may serve as a user-customized terminal.

The Terminal may be configured to perform: in response to a configuration update event, acquiring initial current configuration information, wherein the initial current configuration comprises extended configuration sub-information with a configuration modification identifier; adjusting the configuration modification identifier based on the configuration update event to obtain target current configuration information; acquiring historical configuration information, wherein the historical configuration information comprises historical extended configuration sub-information with a historical configuration modification identifier; determining a configuration change result corresponding to the configuration update event based on the configuration modification identifier in the target current configuration information and the historical configuration modification identifier; and performing resource reloading based on configuration data of the configuration update event when the configuration change result shows configuration has been changed.

Specifically, the server 20 may store partial or complete configuration data for the update event.

The following sections provide detailed explanations. It should be noted that the order of embodiment descriptions does not indicate preference priority.

Embodiments of the present disclosure will be described from the perspective of a resource reloading apparatus, which may be integrated into a terminal.

As shown in FIG. 2, the workflow of the resource reloading method in this embodiment is as follows:

In 201: In response to a configuration update event, acquiring initial current configuration information, wherein the initial current configuration includes extended configuration sub-information with a configuration modification identifier.

The configuration update event refers to any event causing changes to system or application configurations. Such events notify relevant systems or applications to perform corresponding operations based on new configurations.

For example, the configuration update event may be: user-initiated events for modifying application color schemes or system transition animations.

The initial current configuration information represents the configuration information in which configuration parameters are not modified at the current moment. For instance, in Android systems, the initial current configuration information could be the native Configuration class from AOSP (Android Open Source Project).

The extended configuration sub-information refers to a kind of information which is additionally configured for the configuration information. The extended configuration sub-information may be customized by a technician, and configured as sub-information in the initial current configuration information or the target current configuration information.

For example, technicians may create a customized ConfigurationExt class, which is a customized configuration class. An instance of this class acts as a member variable of the native AOSP Configuration class. When AMS (ActivityManagerService) triggers a configuration update, it determines if the configuration has changed through some member methods within Configuration. The customized ConfigurationExt, as a member variable of the native Configuration, will participate in the judgment of Configuration changes, affecting the judgment result. The impact on the judgment result will cause the system to believe that the configuration has changed, notifying the application side, leading to resource reloading and UI updates for the application.

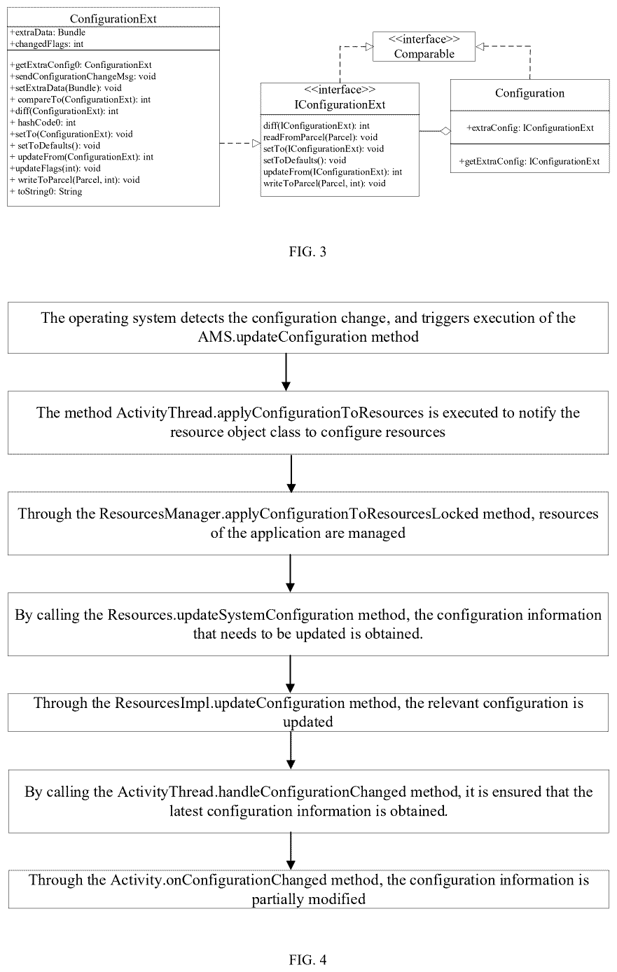

For example, in practical applications, the relationship between the customized ConfigurationExt class (as customized by technicians) and the native Configuration class, can be shown in the UML (Unified Modeling Language) class diagram for customized configurations provided in FIG. 3.

Specifically, the class diagram shows a set of classes, interfaces, collaborations, and their relationships. The visibility of class attributes and operations is indicated by “+”, “#”, and “−” for “public”, “protected”, and “private”, respectively. Interfaces are represented by <<interface>> in the class diagram.

For instance, in FIG. 3, through connection relationships and so on, it can be shown that the interface class IConfigurationExt and the Configuration class are implemented via the Comparable interface. There is an aggregation relationship between the interface class IConfigurationExt and the Configuration class, and the ConfigurationExt class is implemented based on the interface class IConfigurationExt.

In the ConfigurationExt class, there are extraData: Bundle and changedFlags, whose attributes are: int. Through the ConfigurationExt class, operations such as “compare To” and “diff” can be implemented.

Among them, the configuration change flag is an identifier indicating whether the extended configuration sub-information has changed.

For example, the Bundle member variable defined in the customized ConfigurationExt class is used to save some data when the configuration changes; the changedFlags of this class serves as an identifier for configuration changes; the updateFlags method of this class is used to update the identifier. The changedFlags information is the configuration change identifier.

In 202: Adjusting the configuration modification identifier based on the configuration update event to obtain target current configuration information.

The target current configuration information refers to the configuration information when the configuration parameters are modified at the moment. For instance, in Android systems, the target current configuration information may be the Configuration class with altered changedFlags in ConfigurationExt.

In some embodiments, the operation of adjusting the configuration modification identifier based on the configuration update event to obtain target current configuration information may include:
determining an update condition corresponding to the configuration update event based on the configuration update event; when the update condition belongs to a preset configuration modification criteria;
obtaining a target modification identifier corresponding to the update condition from a predefined modification identifier set;
modifying an attribute value of the configuration modification identifier to the target modification identifiers to obtain the target current configuration information.

For example, when certain conditions change, the current Configuration can be retrieved, and the ConfigurationExt class member variable within it can be extracted. The changedFlags identifier in ConfigurationExt is then modified via the updateFlags method.

It is understandable that different configuration modification conditions may correspond to different target modification identifiers. For instance, configuration modification condition 1 could correspond to modification identifier 1, while configuration modification condition 2 could correspond to modification identifier 2.

Alternatively, various configuration modification conditions might share the same target modification identifier. That is, whenever a configuration update event meeting the modification conditions occurs, the configuration modification identifier is set to a specific target identifier.

In 203: Acquiring historical configuration information, wherein the historical configuration information comprises historical extended configuration sub-information with a historical configuration modification identifier.

The historical configuration information may directly be the initial current configuration information. Alternatively, it may represent the system's or application's most primitive configuration information.

In 204: Determining a configuration change result corresponding to the configuration update event based on the configuration modification identifier in the target current configuration information and the historical configuration modification identifier.

The configuration change result may indicate either configuration changes occurred or no changes. The form and content of this result can be customized by technicians, which is not limited in the present disclosure.

In some embodiments, the current configuration information further includes original configuration sub-information, and the historical configuration information includes historical original configuration sub-information. The operation of determining the configuration change result corresponding to the configuration update event based on the configuration modification identifier in the target current configuration information and the historical configuration modification identifier may include:
determining an information change result corresponding to the configuration update event based on the original configuration sub-information in the target current configuration information and the historical original configuration sub-information in the historical configuration information;
comparing the configuration modification identifier in the target current configuration information with the historical configuration modification identifier in the historical configuration information to determine an identifier change result corresponding to the configuration update event;
determining the configuration change result corresponding to the configuration update event based on the identifier change result and the information change result.

For instance, when AMS triggers configuration updates, it uses member methods in Configuration to detect whether the configuration is changed. The customized ConfigurationExt participates in this detection as a member variable of the native Configuration class, influencing determination results. This impact on the judgment result causes the system to believe that the configuration has changed, notifying the application side, which leads to application resource reloading and UI updates.

In some embodiments, the information change result can be obtained by comparing the original configuration sub-information with the historical original configuration sub-information using a specific comparison method. That is, the operation of determining the information change result corresponding to the configuration update event based on the original configuration sub-information in the target current configuration information and the historical original configuration sub-information in the historical configuration information may include:
taking the initial current configuration information as invocation parameters to call a configuration update method in a process management service, wherein the configuration update method comprises a configuration information comparison method;
comparing the original configuration sub-information with the historical original configuration sub-information through the configuration information comparison method to determine the information change result.

For example, the current Configuration can be passed as a parameter to reflectively call the updateConfiguration method of ActivityManagerService.

In some embodiments, the original configuration sub-information includes at least one type of original device configuration feature, and the historical original configuration sub-information includes at least one type of historical original device configuration feature. Types of the historical original device configuration feature and the original device configuration feature are identical.

Correspondingly, the operation of comparing the original configuration sub-information with the historical original configuration sub-information through the configuration information comparison method to determine the information change result may include:

using the configuration information comparison method to compare the original device configuration feature in the original configuration sub-information with the historical original device configuration feature in the historical original configuration sub-information of a same type to determine the information change result.

For example, Configuration comparison methods may perform feature-by-feature comparisons for each involved configuration item (e.g., screen density, orientation, language, etc.)

The subsequent call flow of the updateConfiguration of AMS will compare the differences between the current Configuration and the previous Configuration, using some of Configuration's comparison methods (e.g., compareTo, diff, etc.) to confirm whether the configuration has changed in the form of bit flags.

In some embodiments, through instrumentation, customized ConfigurationExt participates in comparisons, which may invoke ConfigurationExt's comparison methods (compareTo, diff, etc.). The operation of comparing the configuration modification identifier in the target current configuration information with the historical configuration modification identifier in the historical configuration information to determine an identifier change result corresponding to the configuration update event may include:
collecting invocation information of the configuration information comparison method through a preset program probe;
invoking an extended configuration comparison method for the extended configuration sub-information based on the invocation information;
comparing the configuration modification identifier in the target current configuration information with the historical configuration modification identifier in the historical configuration information through the extended configuration comparison method to determine the identifier change result corresponding to the configuration update event.

The program probe refers to program code implemented through instrumentation technology. Instrumentation (hooking) refers to inserting probes into a program while ensuring the integrity of the original program logic. These probes collect information from the code (method itself, method parameter values, return values, etc.) by inserting code segments at specific locations, thereby gathering dynamic context information during program execution.

In 205: Performing resource reloading based on configuration data of the configuration update event when the configuration change result shows configuration has been changed.

In some embodiments, ConfigurationExt's comparison methods check changedFlags between new and old configurations. If the flags are inconsistent, the configuration is considered to have changed, thereby affecting the comparison result of Configuration's comparison method. A change in the comparison result may trigger the mechanism for native resource reloading and UI reconstruction, achieving the update of application resources.

The resources for resource reloading can refer to additional files and static content used by the code, such as bitmaps, layout files, strings, animations, colors, dimensions, etc. At runtime, Android uses appropriate resources based on the current configuration. For example, it may be necessary to provide different UI layouts based on screen size, or different strings based on language settings. After compilation, resources generate a mapping relationship between resource IDs and resource paths or values. When applied, the corresponding resources are found via resource IDs to define the style and attributes of UI elements.

Specifically, configuration data can be all device configuration information that describes resources potentially affecting application retrieval. This includes user-specified configuration options (locale list and scaling) as well as device configurations (such as input mode, screen size, and screen orientation).

In some embodiments, the configuration data include target display data, and the operation of performing resource reloading based on configuration data of the configuration update event when the configuration change result shows configuration has been changed may include:
when the configuration change result shows configuration has been changed, acquiring target display data corresponding to the configuration update event;
halting process restarting, and reloading resources for original display data based on the target display data to render a visual effect corresponding to the target display data.

As shown in FIG. 4, in Android system, the above workflow passes through the ResourcesManager stage where application resources get updated.

For example, if the embodiments of this application are applied to a theme switching scenario in the Android system, based on the user's theme switching operation, when the operating system detects a configuration change, it can execute the AMS. updateConfiguration method to notify the corresponding application that a configuration change has occurred. Furthermore, the method ActivityThread.applyConfigurationToResources can be executed to notify the resource object class corresponding to the theme switching to configure resources.

In the ResourcesManager stage, configuration resources related to theme switching can be managed. For instance, through the ResourcesManager.applyConfigurationToResourcesLocked method, theme package resources can be cached and updated. During subsequent UI reconstruction, resource acquisition can be intercepted to achieve resource overriding.

By calling the Resources.updateSystemConfiguration method, the configuration information that needs to be updated during theme switching can be obtained. Through the ResourcesImpl.updateConfiguration method, the relevant configuration of application performing the theme switching can be updated. By calling the Activity Thread. handleConfigurationChanged method, it is ensured that the latest configuration information is obtained. Through the Activity.onConfigurationChanged method, the part of configuration of the application performing the theme switching, which is directly related to the current theme switching, can be modified.

This innovation can achieve resource reloading and UI reconstruction without killing processes or restarting in this scenario, which may improve user experience. In addition, in scenarios where the existing configuration cannot meet the demand for differentiated UI or functional effects based on configuration, implementing customization through this customized configuration is also an excellent solution.

Most existing technologies adopt callbacks or other notification mechanisms, which have disadvantages such as limited applicability, narrow coverage, and low extensibility. This solution proposed in the present disclosure leverages Android's native resource reloading mechanism during configuration changes through customized configurations, solving real-time configuration updates during interactions that trigger application-side interface refreshes and resource updates. The mechanism offers greater robustness, stability, and convenience, requiring only system-side instrumentation without excessive application adaptation.

Most existing products on the market handle configuration change notifications and resource reloading by UI restarts through methods such as notifications, database listener callbacks, and publish-subscribe. This method cleverly utilizes Android's native Configuration mechanism, offering higher coverage and reliability.

As described above, by adopting the solution described in embodiments of the present disclosure, in response to a configuration update event, initial current configuration information can be obtained. The initial current configuration information includes extended configuration sub-information containing a configuration modification identifier. Based on the configuration update event, the configuration modification identifier is adjusted to derive target current configuration information. Historical configuration information is acquired, which includes historical extended configuration sub-information containing a historical configuration modification identifier. The configuration modification result corresponding to the configuration update event is determined based on the configuration modification identifier in the target current configuration information and the historical configuration modification identifier. When the configuration modification result indicates a configuration change, resource reloading is performed based on the configuration data of the configuration update event. In embodiments of the present disclosure, by determining whether a configuration change has occurred through additionally set extended configuration sub-information, a mechanism has been established where resource reloading can be determined based on the configuration change identifier. Therefore, resource reloading can be completed without restarting the application or the system, improving user experience and achieving real-time resource reloading.

To better implement the above-described method, embodiments of the present disclosure further provides a resource reloading apparatus.

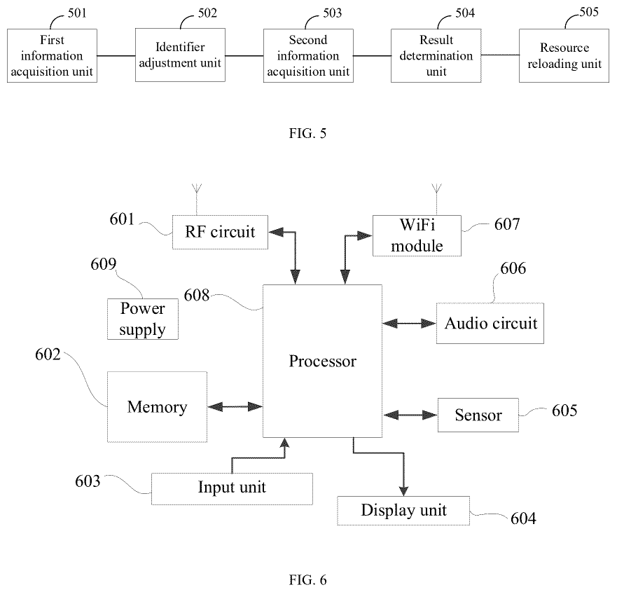

Referring to FIG. 5, the apparatus include:

a first information acquisition unit 501 configured to: in response to a configuration update event, acquire initial current configuration information, wherein the initial current configuration comprises extended configuration sub-information with a configuration modification identifier;

an identifier adjustment unit 502 configured to: adjust the configuration modification identifier based on the configuration update event to obtain target current configuration information;

a second information acquisition unit 503 configured to: acquire historical configuration information, wherein the historical configuration information comprises historical extended configuration sub-information with a historical configuration modification identifier;

a result determination unit 504 configured to: determine a configuration change result corresponding to the configuration update event based on the configuration modification identifier in the target current configuration information and the historical configuration modification identifier; and

a resource reloading unit 505 configured to: perform resource reloading based on configuration data of the configuration update event when the configuration change result shows configuration has been changed.

In some embodiments, the current configuration information further comprises original configuration sub-information, and the historical configuration information comprises historical original configuration sub-information.

The result determination unit 504 is configured to:

determine an information change result corresponding to the configuration update event based on the original configuration sub-information in the target current configuration information and the historical original configuration sub-information in the historical configuration information;

compare the configuration modification identifier in the target current configuration information with the historical configuration modification identifier in the historical configuration information to determine an identifier change result corresponding to the configuration update event;

determine the configuration change result corresponding to the configuration update event based on the identifier change result and the information change result.

In some embodiments, the result determination unit 504 is configured to:

take the initial current configuration information as invocation parameters to call a configuration update method in a process management service, wherein the configuration update method comprises a configuration information comparison method;

compare the original configuration sub-information with the historical original configuration sub-information through the configuration information comparison method to determine the information change result.

In some embodiments, the original configuration sub-information comprises at least one type of original device configuration feature, and the historical original configuration sub-information comprises at least one type of historical original device configuration feature. Types of the historical original device configuration feature and the original device configuration feature are identical.

The result determination unit 504 is configured to: use the configuration information comparison method to compare the original device configuration feature in the original configuration sub-information with the historical original device configuration feature in the historical original configuration sub-information of a same type to determine the information change result.

In some embodiments, the result determination unit 504 is configured to:

collect invocation information of the configuration information comparison method through a preset program probe;

invoke an extended configuration comparison method for the extended configuration sub-information based on the invocation information;

compare the configuration modification identifier in the target current configuration information with the historical configuration modification identifier in the historical configuration information through the extended configuration comparison method to determine the identifier change result corresponding to the configuration update event.

In some embodiments, the identifier adjustment unit 502 is configured to:

determine an update condition corresponding to the configuration update event based on the configuration update event;

when the update condition belongs to a preset configuration modification criteria, obtain a target modification identifier corresponding to the update condition from a predefined modification identifier set;

modify an attribute value of the configuration modification identifier to the target modification identifiers to obtain the target current configuration information.

In some embodiments, the configuration data comprise target display data. The resource reloading unit 505 is configured to:

when the configuration change result shows configuration has been changed, acquire target display data corresponding to the configuration update event;

halt process restarting, and reload resources for original display data based on the target display data to render a visual effect corresponding to the target display data.

As described above, by adopting the resource reloading apparatus, in response to a configuration update event, initial current configuration information can be obtained. The initial current configuration information includes extended configuration sub-information containing a configuration modification identifier. Based on the configuration update event, the configuration modification identifier is adjusted to derive target current configuration information. Historical configuration information is acquired, which includes historical extended configuration sub-information containing a historical configuration modification identifier. The configuration modification result corresponding to the configuration update event is determined based on the configuration modification identifier in the target current configuration information and the historical configuration modification identifier. When the configuration modification result indicates a configuration change, resource reloading is performed based on the configuration data of the configuration update event. In embodiments of the present disclosure, by determining whether a configuration change has occurred through additionally set extended configuration sub-information, a mechanism has been established where resource reloading can be determined based on the configuration change identifier. Therefore, resource reloading can be completed without restarting the application or the system, improving user experience and achieving real-time resource reloading.

Furthermore, embodiments of the present disclosure provide an electronic device. The electronic device may be a terminal or a server. FIG. 6 illustrates the schematic diagram of the electronic device according to an embodiment of the present disclosure. Explanations are given below.

The electronic device may include a radio frequency (RF) circuit 601, a memory 602 including one or more computer-readable storage media, an input unit 603, a display unit 604, a sensor 605, an audio circuit 606, a Wireless Fidelity (WiFi) module 607, a processor 608 including one or more processing cores, and a power supply 609, and so on. Those skilled in the art can understand that the structure of the electronic device shown in FIG. 6 does not constitute a limitation on the electronic device, and may include more or fewer components than illustrated, or combine certain components, or have different component arrangements.

The RF circuit 601 can be used for receiving and transmitting signals during information reception and transmission or calls. Specifically, after receiving downlink information from a base station, it is handed over to one or more processors 608 for processing; in addition, it sends uplink data to the base station. Typically, the RF circuit 601 includes, but is not limited to, an antenna, at least one amplifier, a tuner, one or more oscillators, a Subscriber Identity Module (SIM) card, a transceiver, a coupler, a Low Noise Amplifier (LNA), a duplexer, etc. Furthermore, the RF circuit 601 can also communicate with networks and other devices via wireless communication. Wireless communication can use any communication standard or protocol, including but not limited to Global System for Mobile Communication (GSM), General Packet Radio Service (GPRS), Code Division Multiple Access (CDMA), Wideband Code Division Multiple Access (WCDMA), Long Term Evolution (LTE), email, Short Messaging Service (SMS), etc.

The memory 602 can be used to store software programs and modules. The processor 608 executes various functional applications and data processing by running the software programs and modules stored in the memory 602. The memory 602 may mainly include a storage program area and a storage data area. The storage program area may store an operating system, application programs required for at least one function (such as sound playback function, image playback function, etc.); the storage data area may store data created according to the use of the electronic device (such as audio data, phone book, etc.). In addition, the memory 602 may include high-speed random access memory, and may also include non-volatile memory, such as at least one disk storage device, flash memory device, or other volatile solid-state storage device. Correspondingly, the memory 602 may also include a memory controller to provide the processor 608 and the input unit 603 with access to the memory 602.

The input unit 603 can be used to receive input digital or character information, and to generate keyboard, mouse, joystick, optical, or trackball signal inputs related to user settings and function control. Specifically, in a particular embodiment, the input unit 603 may include a touch-sensitive surface and other input devices. The touch-sensitive surface, also known as a touch display screen or touchpad, can collect touch operations by users on or near it (such as operations by users using fingers, styluses, or any other suitable object or accessory on or near the touch-sensitive surface), and drive corresponding connected devices according to pre-set programs. Optionally, the touch-sensitive surface may include two parts: a touch detection device and a touch controller. The touch detection device detects the user's touch position and the signals generated by the touch operation, and transmits the signals to the touch controller; the touch controller receives touch information from the touch detection device, converts it into touch coordinates, and then sends it to the processor 608, and can receive commands from the processor 608 and execute them. In addition, the touch-sensitive surface can be implemented in various types such as resistive, capacitive, infrared, and surface acoustic wave. In addition to the touch-sensitive surface, the input unit 603 may also include other input devices. Specifically, other input devices may include, but are not limited to, one or more of a physical keyboard, function keys (such as volume control buttons, power buttons, etc.), a trackball, a mouse, a joystick, etc.

The display unit 604 can be used to display information input by the user or provided to the user, as well as various graphical user interfaces of the electronic device. These graphical user interfaces can be composed of graphics, text, icons, videos, and any combination thereof. The display unit 604 may include a display panel, which can optionally be configured in forms such as a Liquid Crystal Display (LCD) or an Organic Light-Emitting Diode (OLED). Furthermore, the touch-sensitive surface can cover the display panel. When the touch-sensitive surface detects a touch operation on or near it, it transmits the information to the processor 608 to determine the type of touch event, and then the processor 608 provides corresponding visual output on the display panel according to the type of touch event. Although in FIG. 6, the touch-sensitive surface and the display panel are implemented as two independent components for input and output functions, in some embodiments, the touch-sensitive surface and the display panel can be integrated to achieve input and output functions.

The electronic device may also include at least one sensor 605, such as an optical sensor, a motion sensor, and other sensors. Specifically, the optical sensor may include an ambient light sensor and a proximity sensor. The ambient light sensor can adjust the brightness of the display panel according to the brightness of the ambient light, and the proximity sensor can turn off the display panel and/or backlight when the electronic device is moved close to the ear. As a type of motion sensor, the gravity acceleration sensor can detect the magnitude of acceleration in various directions (generally three axes). When stationary, it can detect the magnitude and direction of gravity, and can be used for applications that identify phone posture (such as screen rotation, related games, magnetometer posture calibration), vibration recognition related functions (such as pedometers, tapping), etc. As for other sensors that the electronic device may also be configured with, such as gyroscopes, barometers, hygrometers, thermometers, infrared sensors, etc., they will not be described in detail here.

The audio circuit 606, speaker, and microphone can provide an audio interface between the user and the electronic device. The audio circuit 606 can transmit the electrical signals converted from received audio data to the speaker, which converts them into sound signals for output; on the other hand, the microphone converts collected sound signals into electrical signals, which are received by the audio circuit 606 and converted into audio data. This audio data is then processed by the processor 608 and sent via the RF circuit 601 to, for example, another electronic device, or the audio data is output to the memory 602 for further processing. The audio circuit 606 may also include an earphone jack to provide communication between external headphones and the electronic device.

WiFi belongs to short-range wireless transmission technology. The electronic device, through the WiFi module 607, can help users send and receive emails, browse web pages, and access streaming media, etc., providing users with wireless broadband internet access. Although FIG. 6 shows the WiFi module 607, it can be understood that it is not a necessary component of the electronic device and can be omitted as needed without changing the essence of the application.

The processor 608 is the control center of the electronic device, connecting various parts of the entire phone through various interfaces and lines. By running or executing software programs and/or modules stored in the memory 602, and calling data stored in the memory 602, it performs various functions of the electronic device and processes data. Optionally, the processor 608 may include one or more processing cores; preferably, the processor 608 may integrate an application processor and a modem processor, where the application processor mainly handles the operating system, user interface, and applications, etc., and the modem processor mainly handles wireless communication. It can be understood that the aforementioned modem processor may also not be integrated into the processor 608.

The electronic device also includes a power supply 609 (such as a battery) that supplies power to various components. Preferably, the power supply can be logically connected to the processor 608 through a power management system, thereby achieving functions such as charging management, discharging management, and power consumption management through the power management system. The power supply 609 may also include any components such as one or more DC or AC power sources, a recharging system, a power failure detection circuit, a power converter or inverter, a power status indicator, etc.

Although not shown, the electronic device may also include a camera, a Bluetooth module, etc., which will not be described in detail here. Specifically, in this embodiment, the processor 608 in the electronic device will load the executable files corresponding to the processes of one or more applications into the memory 602 according to the following instructions, and the processor 608 will run the applications stored in the memory 602 to achieve various functions, such as the followings:
in response to a configuration update event, acquiring initial current configuration information, wherein the initial current configuration comprises extended configuration sub-information with a configuration modification identifier;
adjusting the configuration modification identifier based on the configuration update event to obtain target current configuration information;
acquiring historical configuration information, wherein the historical configuration information comprises historical extended configuration sub-information with a historical configuration modification identifier;
determining a configuration change result corresponding to the configuration update event based on the configuration modification identifier in the target current configuration information and the historical configuration modification identifier; and
performing resource reloading based on configuration data of the configuration update event when the configuration change result shows configuration has been changed.

Those of ordinary skill in the art can understand that all or part of the steps in the various methods of the above embodiments can be completed by instructions, or by controlling related hardware with instructions, which instructions can be stored in a computer-readable storage medium and loaded and executed by a processor.

Embodiments of the present disclosure further provide a computer-readable storage medium, in which multiple instructions are stored, and these instructions can be loaded by a processor to execute the steps in any of the resource reloading methods provided by the embodiments of this application. For example, the instructions can execute the following steps:
in response to a configuration update event, acquiring initial current configuration information, wherein the initial current configuration comprises extended configuration sub-information with a configuration modification identifier;
adjusting the configuration modification identifier based on the configuration update event to obtain target current configuration information;
acquiring historical configuration information, wherein the historical configuration information comprises historical extended configuration sub-information with a historical configuration modification identifier;
determining a configuration change result corresponding to the configuration update event based on the configuration modification identifier in the target current configuration information and the historical configuration modification identifier; and
performing resource reloading based on configuration data of the configuration update event when the configuration change result shows configuration has been changed.

The specific implementation of each of the above operations can be found in the preceding embodiments, and will not be repeated herein.

The computer-readable storage medium may include: Read Only Memory (ROM), Random Access Memory (RAM), disk or optical disc, etc.

Since the instructions stored in the computer-readable storage medium can execute the steps in any of the resource reloading methods provided by the embodiments of this application, the beneficial effects that can be achieved by any of the resource reloading methods provided by the embodiments of this application can be realized. For details, please refer to the preceding embodiments, which will not be repeated here.

According to one aspect of the present application, a computer program product or computer program is also provided, which includes computer instructions stored in a computer-readable storage medium. The processor of the electronic device reads the computer instructions from the computer-readable storage medium, and the processor executes the computer instructions, so that the electronic device executes the methods provided in various optional implementations in the above embodiments.

The resource reloading method and apparatus, electronic device, and storage medium provided by the embodiments of this application have been described in detail above. Specific examples have been used in this document to illustrate the principles and implementation methods of this application. The description of the above embodiments is only for helping to understand the method and its core ideas of this application. In addition, for those skilled in the art, based on the ideas of this application, there may be changes in specific implementation methods and application scope. In summary, the content of this specification should not be understood as a limitation on this application.

1. A resource reloading method, comprising:
in response to a configuration update event, acquiring initial current configuration information, wherein the initial current configuration comprises extended configuration sub-information with a configuration modification identifier;
adjusting the configuration modification identifier based on the configuration update event to obtain target current configuration information;
acquiring historical configuration information, wherein the historical configuration information comprises historical extended configuration sub-information with a historical configuration modification identifier;
determining a configuration change result corresponding to the configuration update event based on the configuration modification identifier in the target current configuration information and the historical configuration modification identifier; and
performing resource reloading based on configuration data of the configuration update event when the configuration change result shows configuration has been changed.

2. The resource reloading method according to claim 1,
wherein the current configuration information further comprises original configuration sub-information, and the historical configuration information comprises historical original configuration sub-information;
wherein the determining the configuration change result corresponding to the configuration update event based on the configuration modification identifier in the target current configuration information and the historical configuration modification identifier comprises:
determining an information change result corresponding to the configuration update event based on the original configuration sub-information in the target current configuration information and the historical original configuration sub-information in the historical configuration information;
comparing the configuration modification identifier in the target current configuration information with the historical configuration modification identifier in the historical configuration information to determine an identifier change result corresponding to the configuration update event;
determining the configuration change result corresponding to the configuration update event based on the identifier change result and the information change result.

3. The resource reloading method according to claim 2,
wherein the determining the information change result corresponding to the configuration update event based on the original configuration sub-information in the target current configuration information and the historical original configuration sub-information in the historical configuration information comprises:
taking the initial current configuration information as invocation parameters to call a configuration update method in a process management service, wherein the configuration update method comprises a configuration information comparison method;
comparing the original configuration sub-information with the historical original configuration sub-information through the configuration information comparison method to determine the information change result.

4. The resource reloading method according to claim 3,
wherein the original configuration sub-information comprises at least one type of original device configuration feature, and the historical original configuration sub-information comprises at least one type of historical original device configuration feature;
wherein types of the historical original device configuration feature and the original device configuration feature are identical;
wherein the comparing the original configuration sub-information with the historical original configuration sub-information through the configuration information comparison method to determine the information change result comprises:
using the configuration information comparison method to compare the original device configuration feature in the original configuration sub-information with the historical original device configuration feature in the historical original configuration sub-information of a same type to determine the information change result.

5. The resource reloading method according to claim 3,
wherein the comparing the configuration modification identifier in the target current configuration information with the historical configuration modification identifier in the historical configuration information to determine an identifier change result corresponding to the configuration update event comprises:
collecting invocation information of the configuration information comparison method through a preset program probe;
invoking an extended configuration comparison method for the extended configuration sub-information based on the invocation information;
comparing the configuration modification identifier in the target current configuration information with the historical configuration modification identifier in the historical configuration information through the extended configuration comparison method to determine the identifier change result corresponding to the configuration update event.

6. The resource reloading method according to claim 5, wherein the program probe is implemented through instrumentation code that maintains original program logic integrity while inserting detection points.

7. The resource reloading method according to claim 1,
wherein the adjusting the configuration modification identifier based on the configuration update event to obtain target current configuration information comprises:
determining an update condition corresponding to the configuration update event based on the configuration update event;
when the update condition belongs to a preset configuration modification criteria, obtaining a target modification identifier corresponding to the update condition from a predefined modification identifier set;
modifying an attribute value of the configuration modification identifier to the target modification identifiers to obtain the target current configuration information.

8. The resource reloading method according to claim 1,
wherein the configuration data comprise target display data;
wherein the performing resource reloading based on configuration data of the configuration update event when the configuration change result shows configuration has been changed comprises:
when the configuration change result shows configuration has been changed, acquiring target display data corresponding to the configuration update event;
halting process restarting, and reloading resources for original display data based on the target display data to render a visual effect corresponding to the target display data.

9. The resource reloading method according to claim 1, wherein the configuration modification identifier indicates whether the extended configuration sub-information has changed, and resources for resource reloading comprise additional files and static content used by codes.

10-18. (canceled)

19. An electronic device comprising a memory and a processor, wherein the memory is configured to store application programs that, when executed by the processor, cause the processor to perform a resource reloading method;
wherein the resource reloading method comprises:
in response to a configuration update event, acquiring initial current configuration information, wherein the initial current configuration comprises extended configuration sub-information with a configuration modification identifier;
adjusting the configuration modification identifier based on the configuration update event to obtain target current configuration information;
acquiring historical configuration information, wherein the historical configuration information comprises historical extended configuration sub-information with a historical configuration modification identifier;
determining a configuration change result corresponding to the configuration update event based on the configuration modification identifier in the target current configuration information and the historical configuration modification identifier; and
performing resource reloading based on configuration data of the configuration update event when the configuration change result shows configuration has been changed.

20. A non-transitory computer readable medium storing instructions that, when executed by a process, cause the processor to perform a resource reloading method;
wherein the resource reloading method comprises:
in response to a configuration update event, acquiring initial current configuration information, wherein the initial current configuration comprises extended configuration sub-information with a configuration modification identifier;
adjusting the configuration modification identifier based on the configuration update event to obtain target current configuration information;
acquiring historical configuration information, wherein the historical configuration information comprises historical extended configuration sub-information with a historical configuration modification identifier;
determining a configuration change result corresponding to the configuration update event based on the configuration modification identifier in the target current configuration information and the historical configuration modification identifier; and
performing resource reloading based on configuration data of the configuration update event when the configuration change result shows configuration has been changed.

21. The electronic device according to claim 19,
wherein the current configuration information further comprises original configuration sub-information, and the historical configuration information comprises historical original configuration sub-information;
wherein the determining the configuration change result corresponding to the configuration update event based on the configuration modification identifier in the target current configuration information and the historical configuration modification identifier comprises:
determining an information change result corresponding to the configuration update event based on the original configuration sub-information in the target current configuration information and the historical original configuration sub-information in the historical configuration information;
comparing the configuration modification identifier in the target current configuration information with the historical configuration modification identifier in the historical configuration information to determine an identifier change result corresponding to the configuration update event;
determining the configuration change result corresponding to the configuration update event based on the identifier change result and the information change result.

22. The electronic device according to claim 21,
wherein the determining the information change result corresponding to the configuration update event based on the original configuration sub-information in the target current configuration information and the historical original configuration sub-information in the historical configuration information comprises:
taking the initial current configuration information as invocation parameters to call a configuration update method in a process management service, wherein the configuration update method comprises a configuration information comparison method;
comparing the original configuration sub-information with the historical original configuration sub-information through the configuration information comparison method to determine the information change result.

23. The electronic device according to claim 22,
wherein the original configuration sub-information comprises at least one type of original device configuration feature, and the historical original configuration sub-information comprises at least one type of historical original device configuration feature;
wherein types of the historical original device configuration feature and the original device configuration feature are identical;
wherein the comparing the original configuration sub-information with the historical original configuration sub-information through the configuration information comparison method to determine the information change result comprises:
using the configuration information comparison method to compare the original device configuration feature in the original configuration sub-information with the historical original device configuration feature in the historical original configuration sub-information of a same type to determine the information change result.

24. The electronic device according to claim 22,
wherein the comparing the configuration modification identifier in the target current configuration information with the historical configuration modification identifier in the historical configuration information to determine an identifier change result corresponding to the configuration update event comprises:
collecting invocation information of the configuration information comparison method through a preset program probe;
invoking an extended configuration comparison method for the extended configuration sub-information based on the invocation information;
comparing the configuration modification identifier in the target current configuration information with the historical configuration modification identifier in the historical configuration information through the extended configuration comparison method to determine the identifier change result corresponding to the configuration update event.

25. The electronic device according to claim 24, wherein the program probe is implemented through instrumentation code that maintains original program logic integrity while inserting detection points.

26. The electronic device according to claim 19,
wherein the adjusting the configuration modification identifier based on the configuration update event to obtain target current configuration information comprises:
determining an update condition corresponding to the configuration update event based on the configuration update event;
when the update condition belongs to a preset configuration modification criteria, obtaining a target modification identifier corresponding to the update condition from a predefined modification identifier set;
modifying an attribute value of the configuration modification identifier to the target modification identifiers to obtain the target current configuration information.

27. The electronic device according to claim 19,
wherein the configuration data comprise target display data;
wherein the performing resource reloading based on configuration data of the configuration update event when the configuration change result shows configuration has been changed comprises:
when the configuration change result shows configuration has been changed, acquiring target display data corresponding to the configuration update event;
halting process restarting, and reloading resources for original display data based on the target display data to render a visual effect corresponding to the target display data.

28. The electronic device according to claim 19, wherein the configuration modification identifier indicates whether the extended configuration sub-information has changed, and resources for resource reloading comprise additional files and static content used by codes.
